(19) United States
(12) Patent Application Publication
(10) Pub. No.: US 2007/0182820 A1
(43) Pub. Date: Aug. 9, 2007

(54) Hitch-Mounted Safety Detection System for Automobiles

(76) Inventor: Dennis H. Wang, Pasadena, CA (US)

Correspondence Address: PHILIP K. YU, 20955 PATHFINDER ROAD, SUITE 100, DIAMOND BAR, CA, 91765, US

(21) Appl. No.: 11/670,377

(22) Filed: Feb. 1, 2007

Related U.S. Application Data
(60) Provisional application No. 60/765,045, filed on Feb. 3, 2006.

(51) Int. Cl. H04N 7/18; B60Q 1/00; G08G 1/14

(52) U.S. Cl. 348/148; 340/435; 340/932.2

(57) ABSTRACT

The present invention is directed to a sensor or camera system that can be readily mounted to the existing hitch socket of an automobile such as an SUV, minivan or RV. The system also can use the existing hitch wiring for its power source. The sensor or camera system can fit into any automotive hitch system, whether the hitch is factory-installed or after-market. The installed sensor, camera, or illuminating devices can be easily secured or locked by a hitch pin or hitch locking pin. For simplicity, the overall system will be generally referred to, in the following description. It should be apparent to those skilled in the art that the detection system may include sensors, cameras or both.

### PRIORITY CLAIMED

This application claims benefit under 35 U.S.C. § 119(e) of U.S. Provisional Application No. 60/765,045, filed Feb. 3, 2006, entitled Hitch-mounted Safety Detection System for Automobiles, the entirety of which is hereby incorporated herein by reference.

### FIELD OF THE INVENTION

The present invention relates to safety devices for automobiles, and more particularly relates to detection systems for detecting children or objects in the blind spots of an automobile such as an SUV, RV, minivan or trailer.

### BACKGROUND OF THE INVENTION

SUVs and minivans have become quite popular in the US in recent years. Despite their design improvement, the typically massive chassis size has created quite a few blind spots for the drivers. One critical blind spot is in the rear, where the elevated chassis prevents the driver from seeing whether a child or an object is behind when backing up. Numerous unfortunate accidents have occurred, where small children or animals were injured or killed when the drivers failed to notice them while backing up.

To provide better visibility, some SUVs and minivans have installed sensors or video cameras, which first scan the desired areas around the vehicle, and then relay the detection, as audio or visual signals, to the drivers. Scanning requires a sensor or a camera be set up at the rear end of the vehicle, from which wires are routed to an output device near the driver's seat. Such installation is quite cumbersome and complicated, thus requiring the work to be performed at a dealership or a specialty shop, if it is not already installed from the factory. The cost and complication turns out to be not conducive to a widespread adoption of the technology.

Therefore, it would be desirable to be able to simplify the installation of the detection system.

It would also be desirable to be able to install the detection system without extensive wiring.

It would further be desirable to be able to install the detection system by taking advantage of existing structure of the vehicle.

### SUMMARY OF THE INVENTION

The present invention is directed to a sensor or camera system that can be readily mounted to the existing hitch socket of an automobile such as an SUV, minivan or RV. The system also can use the existing hitch wiring for its power source. The sensor or camera system can fit into any automotive hitch system, whether the hitch is factory-installed or after-market. The installed sensor, camera, or illuminating devices (collectively hereinafter “detection elements”) can be easily secured or locked by a hitch pin or hitch locking pin. For simplicity, the overall system will be generally referred to, in the following description, as a “detection system.” It should be apparent to those skilled in the art that the detection system may include sensors, cameras or both.

The electronic components and circuits are preferably contained or embodied within the sensor units, or the detection elements. A connection wire is extended from the detection elements by plugging directly into the vehicle's existing wiring harness receptacle, or hitch power supply receptacle. Of course, an optional connector may be provided for those vehicles without any pre-installed hitch wiring.

Lighting devices, such as light bulbs or LED devices, for providing illumination to the target area(s) may also be incorporated into the detection system, preferably using the same power source. The illumination can serve to provide better imaging effect, as well as act as a back-up alert device.

To power the detection system, the hitch power supply in the vehicle is preferably used, regardless of the type (4 pin, 5 pin, 7 pin, . . . etc.). The detection system can be directly plugged into the existing hitch power receptacle, thus making it a PLUG-and-PLAY system.

Upon activation of the sensor(s), camera(s) or both, preferably when the vehicle is shifted into reverse, detection may be communicated to the driver in two exemplary methods. The first exemplary method is to provide an audible signal generated by the detection system at the hitch. The other exemplary method is to use wireless signals to transmit the detection signals, audio or video or both, into an in-car receiver, which powers a speaker or a display. The in-car receiver may be readily powered by the existing cigarette lighter adaptor. The video signals, when transmitted wirelessly, can work with a dash-mounted display, glass-mounted (common known as “heads-up display,” HUD) display, or interface with the vehicle's built-in display (navigation/entertainment/DVD, . . . etc), or aftermarket displays.

Whether it is a hitch-mounted sensor or hitch-mounted camera, it can be mounted in the same way and powered by the same power source from the hitch power socket. The detection signal can also be transmitted to the passenger cabin via wireless signaling. Additionally, a combined hitch sensor and camera system may be implemented, which utilizes the same mounting method and power source.

The detection system is not limited to just one sensor. Multiple sensors may be installed, where they are fine-tuned to accommodate different width of the vehicle to optimize coverage area.

The power source that powers the detection system may be constant on, switched on, or activated by reverse shift.

### BRIEF DESCRIPTION OF THE DRAWINGS

FIG. 1 illustrates a compact hitch-mounted sensor, sensor/camera, camera-only, or camera/lights detection system 10.

FIG. 2 illustrates a heavier-duty hitch-mounted sensor or sensor/camera detection system 20.

FIG. 3 illustrates a hitch-mounted detection system with an additional hitch adaptor (tentatively called “Detection PLUS”).

FIG. 4 illustrates the Detection Plus system 30, through which a ball mount 42 can be fitted through the opening 33.

FIG. 5 illustrates a larger and wider hitch-mounted detection system 50, where the detection elements 24 are positioned to cover a wider angle.

FIG. 6 illustrates the larger hitch-mounted detection system 60, with an opening 33, for allowing an accessory such as a ball mount 42 to be fitted through.

FIG. 7 illustrates a bike rack 70 mounted on the hitch 31.

FIG. 8 illustrates a bike rack/carrier 70 with an add-on detection system 82.

FIG. 9 illustrates a carrier, e.g. wheel chair carrier, with a built-in detection elements 92, connected to the hitch.

FIG. 10 illustrates a hitch-mounted ball mount 42, with an add-on detection system 42.

FIG. 11 illustrates a detection system 110 that is mounted directly onto the hitch power source 12.

FIG. 12 illustrates the passenger cabin's dash board 128, where a wireless receiver 120 can be plugged directly into the cigarette lighter adapter 125.

FIGS. 13 (a) and (b) illustrate the overall detection system in accordance with the present invention is shown.

FIG. 14 illustrates a detection system based on an after-market hitch 140, where the sensors 142 or cameras 144 are built-in with the after-market hitch 140.

FIG. 15 illustrates a detection system that is attachable to a hitch accessory such as a bike rack or a sports rack.

### DETAILED DESCRIPTION OF THE PREFERRED EMBODIMENTS

A hitch-mounted detection system is disclosed. In the description that follows, numerous aspects of the invention have been described using specific terms that are common to those skilled in the art in communicating their ideas to their colleagues. The intent, however, is to accurately describe the invention, but without being limited to any specific implementation or embodiment. With respect to other aspects, the invention is described in general terms so as not to obscure the invention.

The present invention is directed to a detection system that can be readily mounted to the existing hitch socket of an automobile such as an SUV, minivan or RV. The detection system preferably uses the existing hitch wiring for its power source. The detection system is adapted to readily fit into any standardized automotive hitch system, whether the hitch is factory-installed or after-market. The installed detection elements (e.g. sensor, camera, or illuminating device) can be easily secured or locked by a hitch pin or hitch locking pin.

The detection system, in accordance to the present invention, has the following salient features:

A: Hitch Sensor: The detection element is mounted directly into the hitch receptacle.

B: Hitch Sensor/Camera: Same as “A” above, but is a sensor-camera combination or camera only.

C: Hitch Sensor-PLUS: The detection element is mounted directly to the hitch receptacle, around the receiver opening. This mounting method does not affect the hitch receptacle opening; nor does it affect the mounting of a towing device or accessory devices. Towing devices or other accessories may still be installed and used without having to remove the detection element.

D: Hitch Sensor/Camera-PLUS: Similar to “C” above, except as sensor/camera combination, or camera only.

E: Ball-Mount Type: The detection element is mounted to the hitch ball mount.

F: Built-In Type: Hitch sensor built-in on accessory or equipment racks (e.g. bike rack, ski rack, wheelchair lift, hitch and carry, and other hitch-mountable sport rack)

G: Power Mount: This additional mounting methodology is to plug the detection element (e.g. sensor, or sensor/camera combination) directly into the hitch power supply at the rear of the vehicle. Additional locking mechanism may be provided to secure the detection element.

Advantages of the present invention are summarized as follows:

The hitch-mounted detection system eliminates installation cost.

The hitch-mounted detection system can be mounted to trucks, SUVs, minivan, cars, or trailers.

The hitch-mounted detection system can be secured using a standard hitch locking pin.

The easily mountable detection system adds safety to cars that need it the most.

The hitch-mounted detection system requires no additional wiring. It uses wiring for those hitches already installed with hitch wiring.

The hitch-mounted detection system has optional wiring connectors, for those hitches without pre-installed hitch wiring.

The hitch-mounted detection system does not affect or compromise towing, or other hitch accessories.

The hitch-mounted detection system offers a simple, effective, and economical value proposition to those safety conscious drivers.

### DETAILED DESCRIPTION OF THE DRAWINGS

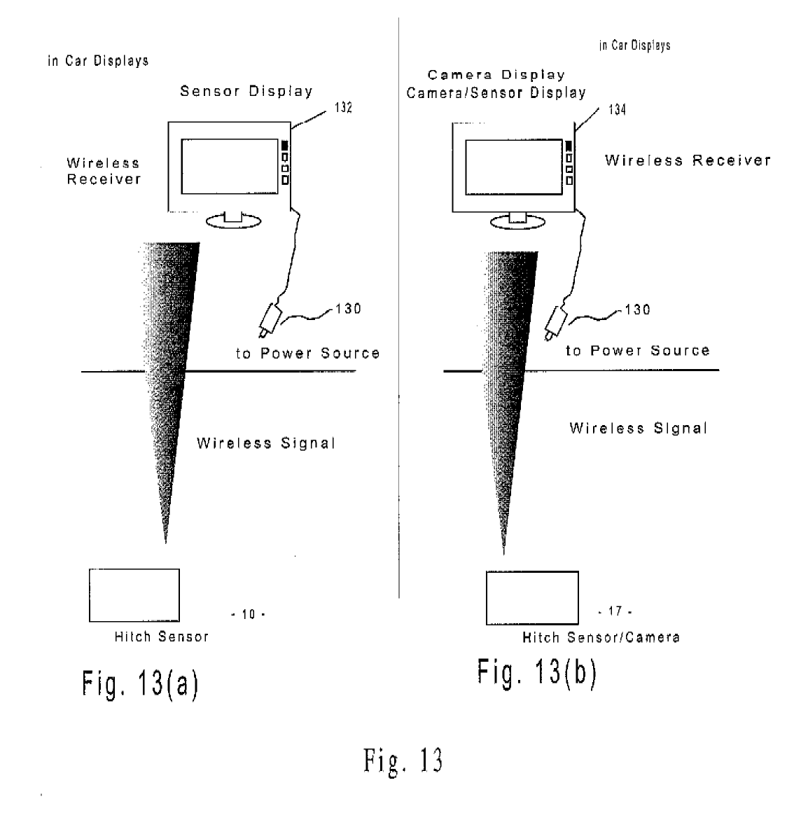

Reference is first made to FIGS. 13 (a) and (b), where an exemplary detection system in accordance with the present invention is illustrated. In FIG. 13(a), a hitch-mounted detection element, e.g. sensor 10 (to be described), transmits its detection signals wirelessly to an in-car wireless receiver and display 132. The in-car receiver and display 132 then provides the detection information to the user. For ease of installation, the receiver and display 132 is powered by the in-car cigarette lighter 130. The displayed information may visually look like a “radar detection pattern” for a designated scanning area.

In FIG. 13 (b), the hitch-mounted detection element, e.g. sensor/camera unit 17, wirelessly forwards its detection signals to a wireless receiver and display 134. Upon receipt, the signals are displayed to the user, so that the user can visually observe the scanned area, i.e. the rear-end of the vehicle. The receiver and display 134 is also easily powered by the cigarette lighter. It should be noted that the display may be an on-board display that is already provided for navigation and control purposes. As such, the wireless receiver, which is powered by the cigarette lighter or other on-board power source, forwards the received detection signals to the on-board display via wireless or wired connections. As can be appreciated, many wireless communication methods are currently available, e.g. IEEE 802.11(a), (b) or (g), Bluetooth, etc.

Preferably, when the car ignition is started or the gear put in reverse, an operation status check is performed to ensure that the hitch sensor 10, 17 is still connected and operational. Such operation status check may be initiated by powering on the display 132, 134, to ensure that the sensors are connected and the wireless transmission is operational.

Also, it is noted that the hitch, where the detection element is mounted, may be factory-installed or installed as an after-market item. While many sedans do not have factory-installed hitches, the owners are nevertheless free to purchase such after-market items if they have the need for a hitch, which allows them to use a bike rack or equipment rack.

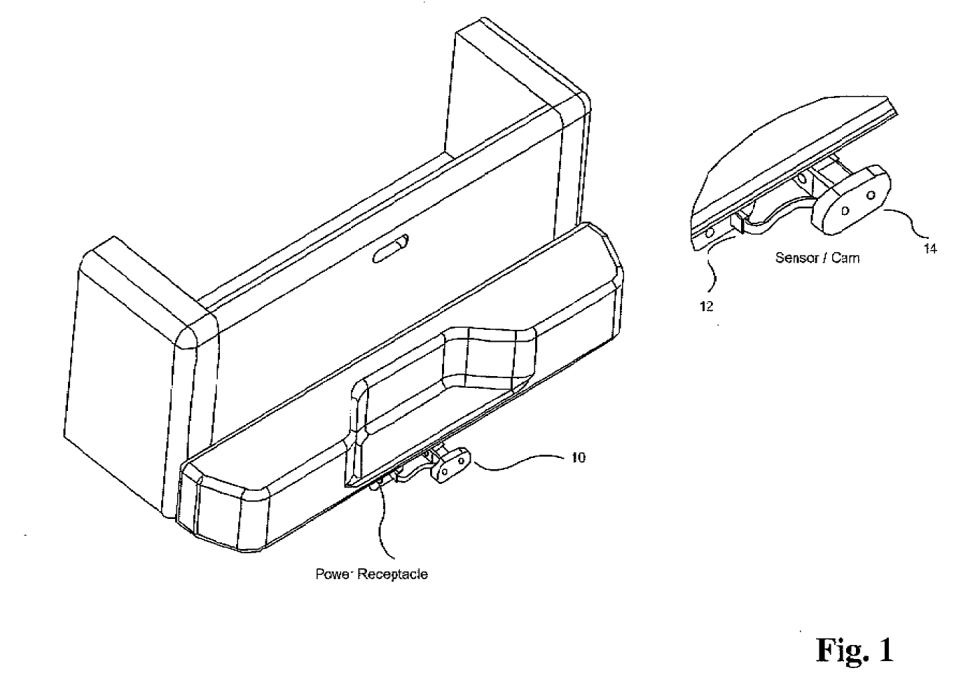

Reference is now turned to various exemplary embodiments in accordance with the present invention. FIG. 1 illustrates a compact hitch-mounted detection system 10, which includes a sensor, sensor/camera, camera-only, or camera/lights as its detection element. The detection system 10 can be implemented like a common hitch plate or hitch ornament, where the sensors/cameras 14 are installed on the plate. Power is provided through the existing standard hitch power plug 12. Detection signals are preferably transmitted via wireless channels to the passenger cabin for audio or video display. Use of the existing hitch power plug and wireless channel eliminates the cumbersome wire routing, thus greatly simplifying the installing.

This detection system 10 is about the size of a common hitch cover plate, or a little larger. This hitch sensor, camera, and lighting devices 14 can be installed or integrated in the body of the hitch cover.

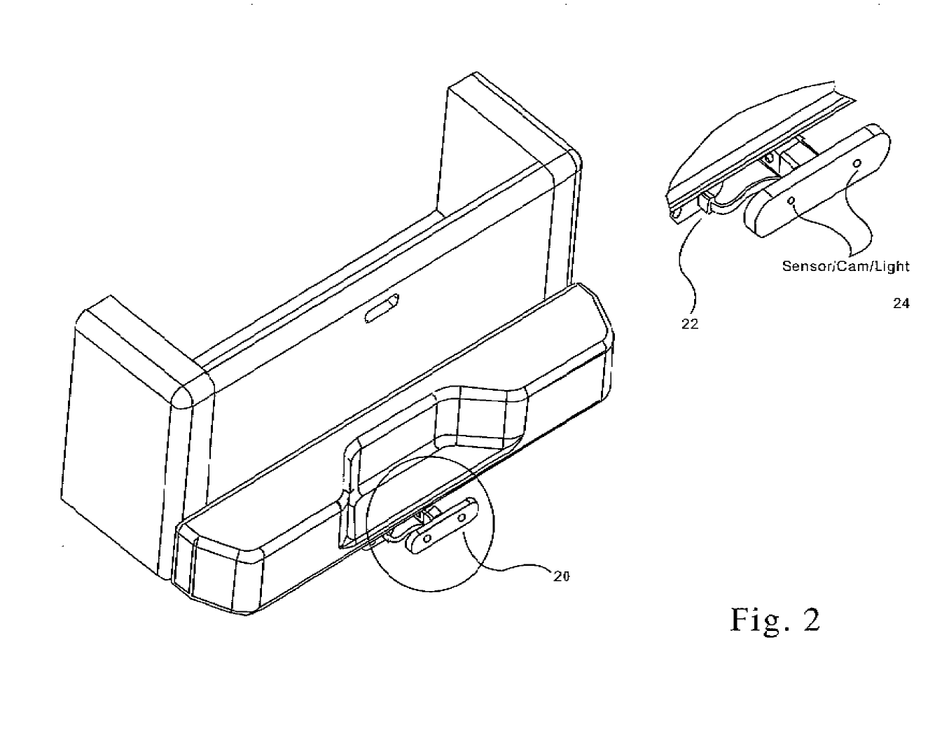

FIG. 2 illustrates a heavier-duty hitch-mounted detection system 20 with one or more sensor or sensor/camera combo. The physical dimension of the system may be a little larger, so that more sensors, cameras, lighting devices, or combination thereof 24, may be populated. The structure is a heavier-duty unit, and can also be used as a “step” if needed. Since more detection elements, i.e. sensors, cameras, LEDs or combination thereof, are implemented, a wider detection area can be covered.

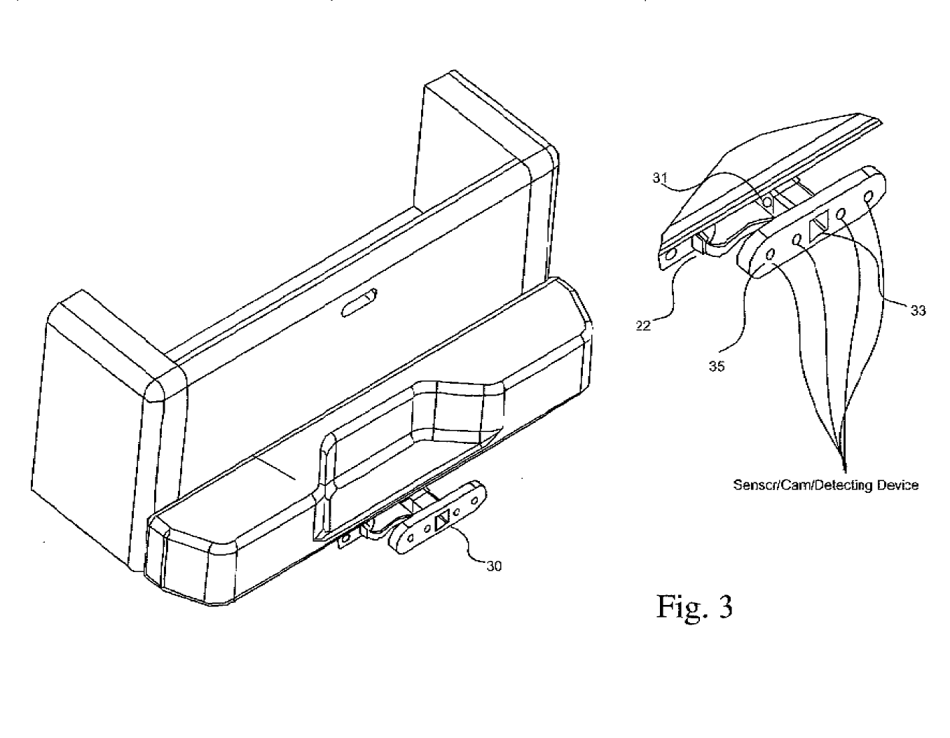

FIG. 3 illustrates a hitch-mounted detection system 30 with an additional hitch adaptor (tentatively called “Detection PLUS”). The detection system 30 can be implemented with any combination or number of detection elements 35. An opening 33, or receptacle, on the detection system 30 is aligned with the vehicle's existing hitch, thus rendering the vehicle's existing hitch 31 still usable as a hitch.

The “detection PLUS” structure is basically the same as shown in FIG. 2, except that the hitch receptacle of the existing hitch 31 is not blocked. As such, the receive function and utility of the hitch is preserved. Even with the implementation of this “detection PLUS” device, the vehicle can still use the hitch receptacle for towing, or for mounting other accessories, such as a bike rack, canoe rack or sport equipment rack.

Additional wiring sockets 35 can be provided on the detection system 30 for the hitch, by extending power from the existing hitch wiring plug 22.

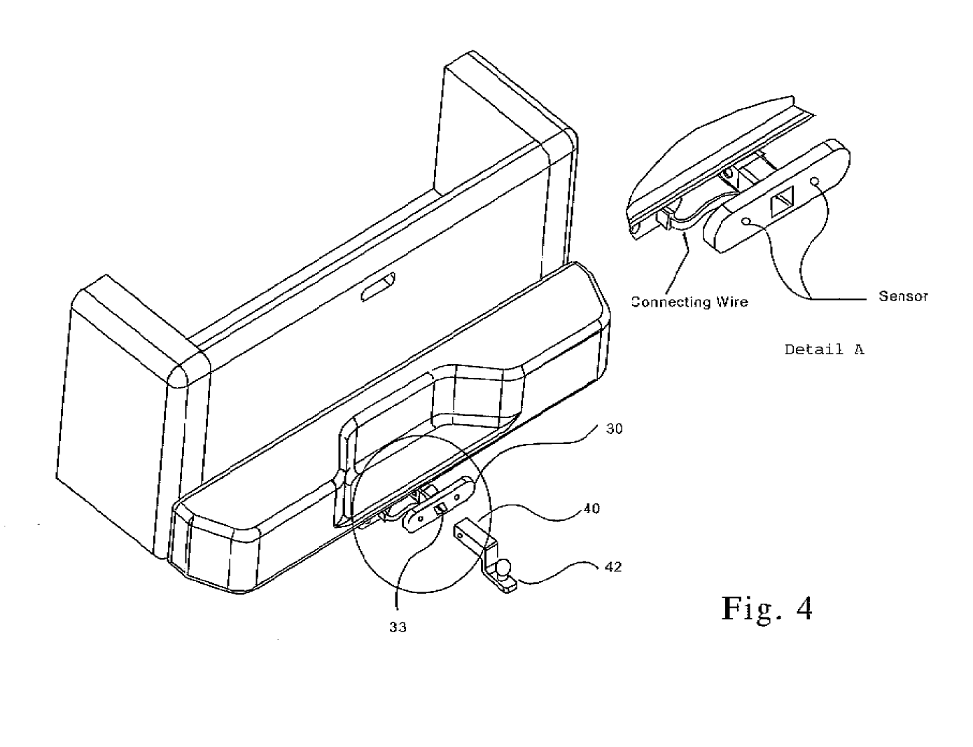

FIG. 4 illustrates the “Detection PLUS” system 30, where the stem 40 of a ball mount 42 can still be fitted through the opening 33, or receptacle. This nested system allows greater flexibility without compromising safety.

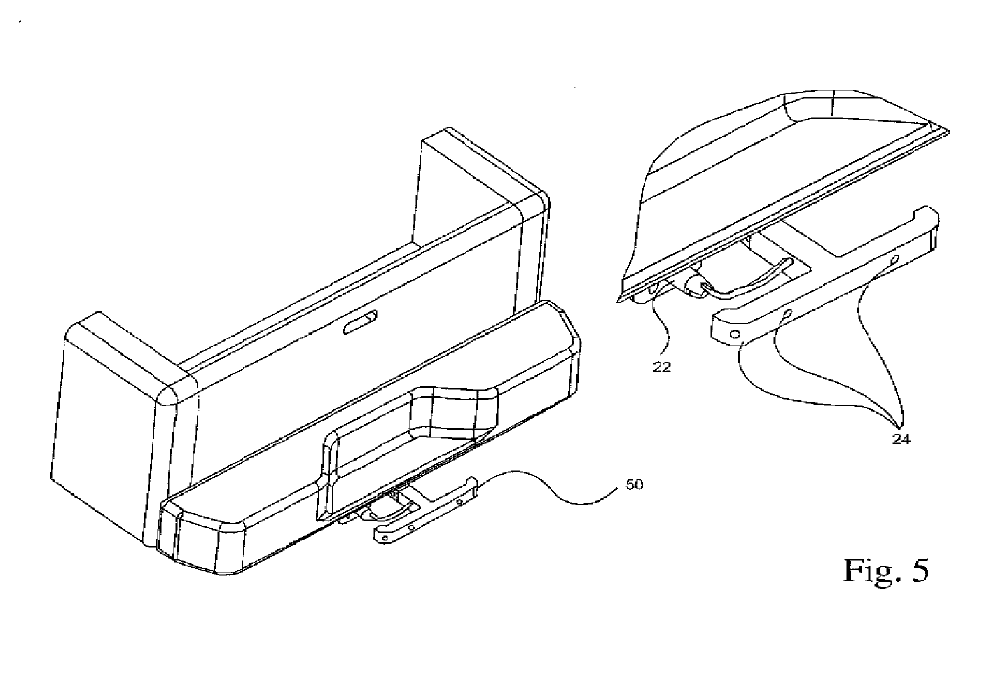

FIG. 5 illustrates a larger and wider hitch-mounted detection system 50, where the detection elements 24 are positioned to cover a wider angle. Again, the larger form factor of the detection system can also serve as a “step bumper.”

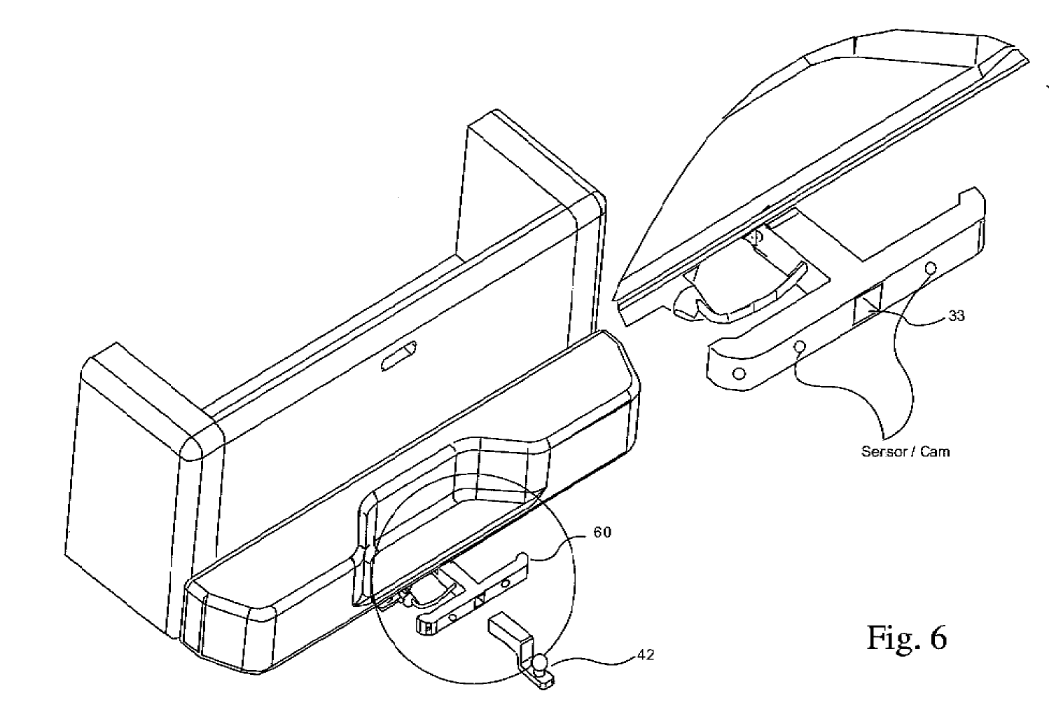

FIG. 6 illustrates a larger hitch-mounted detection system 60, with an opening, or receptacle, 33, for allowing an accessory such as the stem of a ball mount 42 to be fitted through.

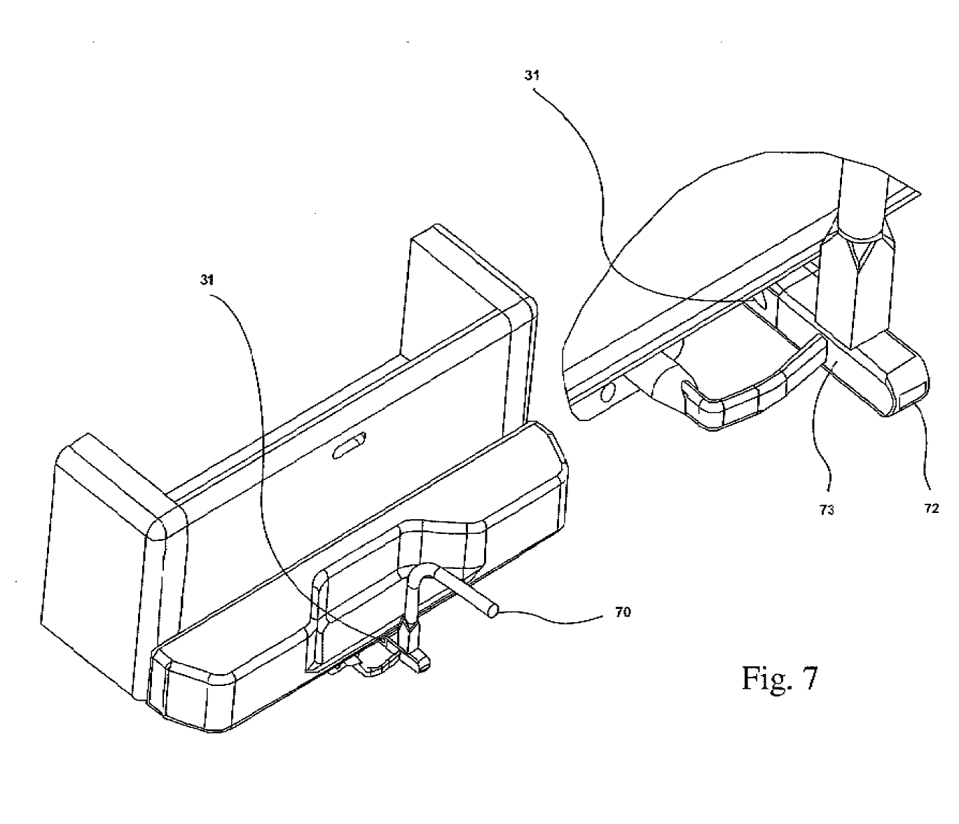

FIG. 7 illustrates an exemplary bike rack 70 mounted on the hitch 31. A detection system 73 with detection element(s) 72 is preferably built-in on the bike rack 70. Alternately, the detection system 73 may be an add-on unit for the bike rack, or any accessory rack. It should be apparent to those skilled in the art that this aspect of the present invention is not limited to just bike racks. Sport equipment rack, wheel chair lift or other mounting accessories can also deploy the detection system in accordance with the present invention.

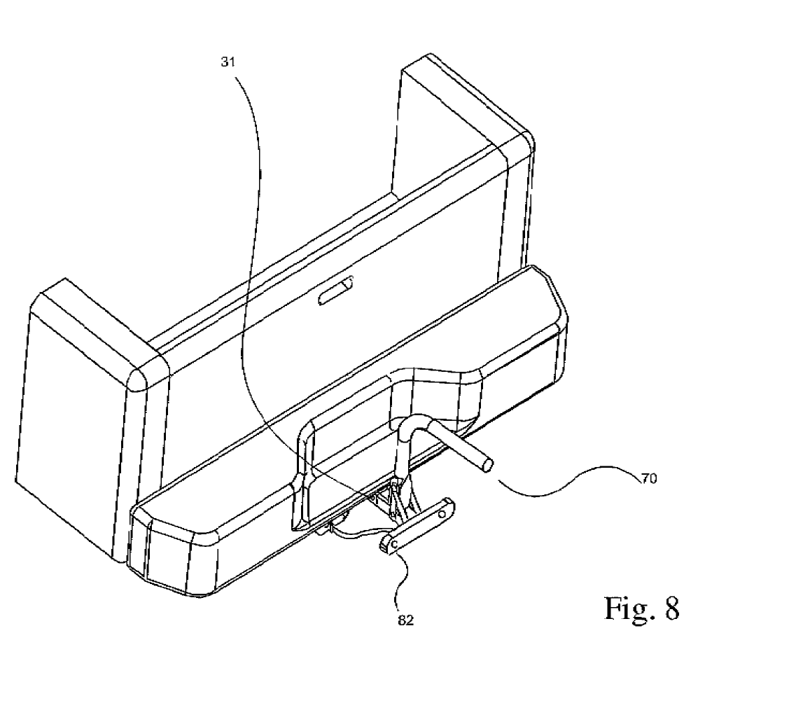

FIG. 8 illustrates an exemplary bike rack/carrier 70 with an add-on detection system 82. Alternately, a “T-shaped,” or three-way, joint adapter may connect the bike rack 70 and detection system 82 to the hitch 31.

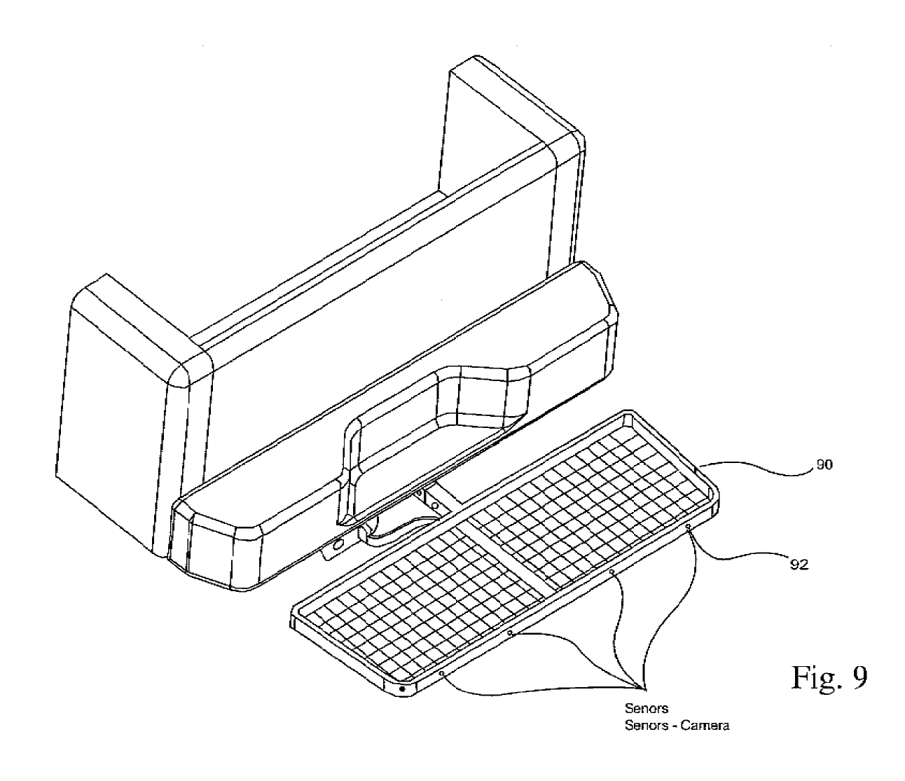

FIG. 9 illustrates an exemplary carrier, e.g. wheel chair carrier, with built-in detection elements 92, connected to the hitch. A driver's rear view is particularly blocked when a wheel chair or power tool is carried in the back. With the detection elements implemented on the wheel chair carrier 90 and powered by the hitch power source, such blind spots are eliminated.

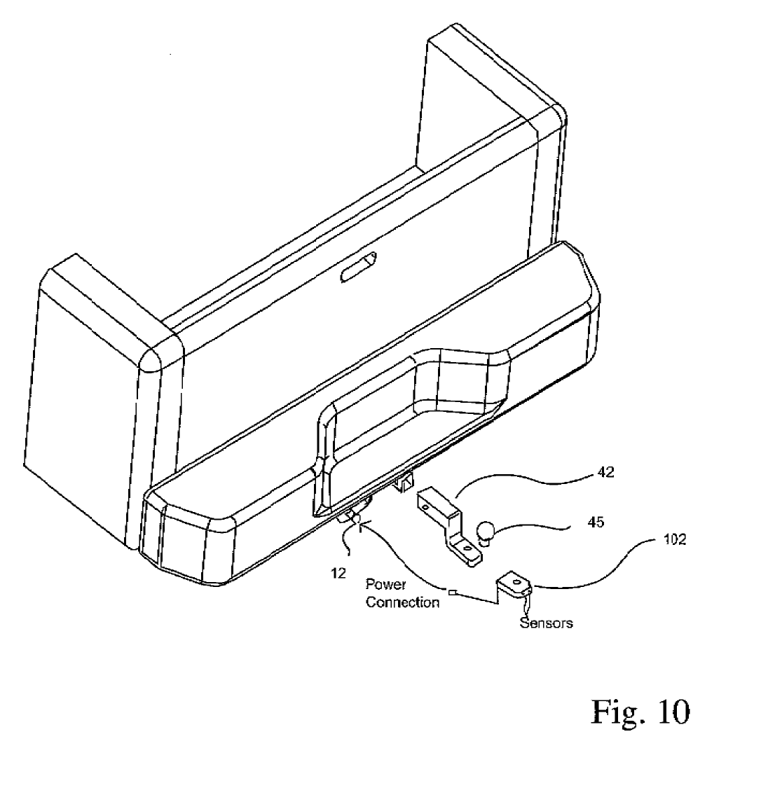

FIG. 10 illustrates an exemplary hitch-mounted ball mount 42, with an add-on detection system 42. A trailer ball 45 can be used to secure the detection system 102 through the opening. With the detection system 102 attached, the ball mount 42 can still be used to connect to a trailer. Since the detection system 102 is mounted on the ball mount, it will not affect its towing capability or function. The detecting elements, e.g. sensor units, are sandwiched between the hitch ball-mount and hitch-ball 45.

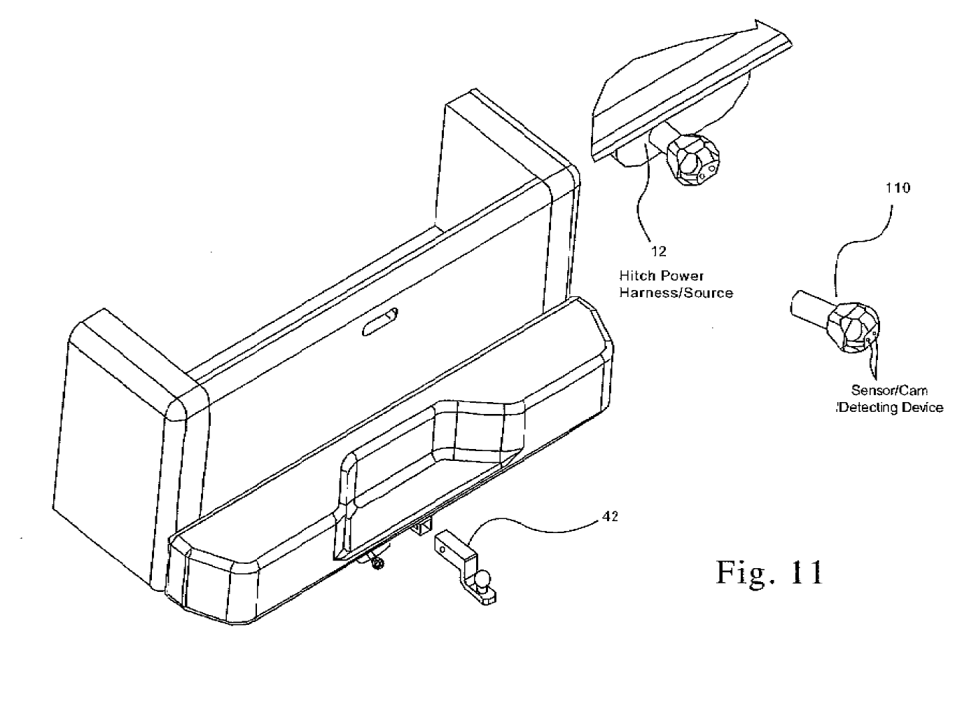

FIG. 11 illustrates an exemplary detection system 110 that is mounted directly onto the hitch power source 12. The detection system 110 may have sensors, camera, lighting elements, or combination thereof, built-in. The angle of the detection system may be made adjustable. And a locking mechanism (not shown) for the locking the detection system to the power plug 12 is also preferred.

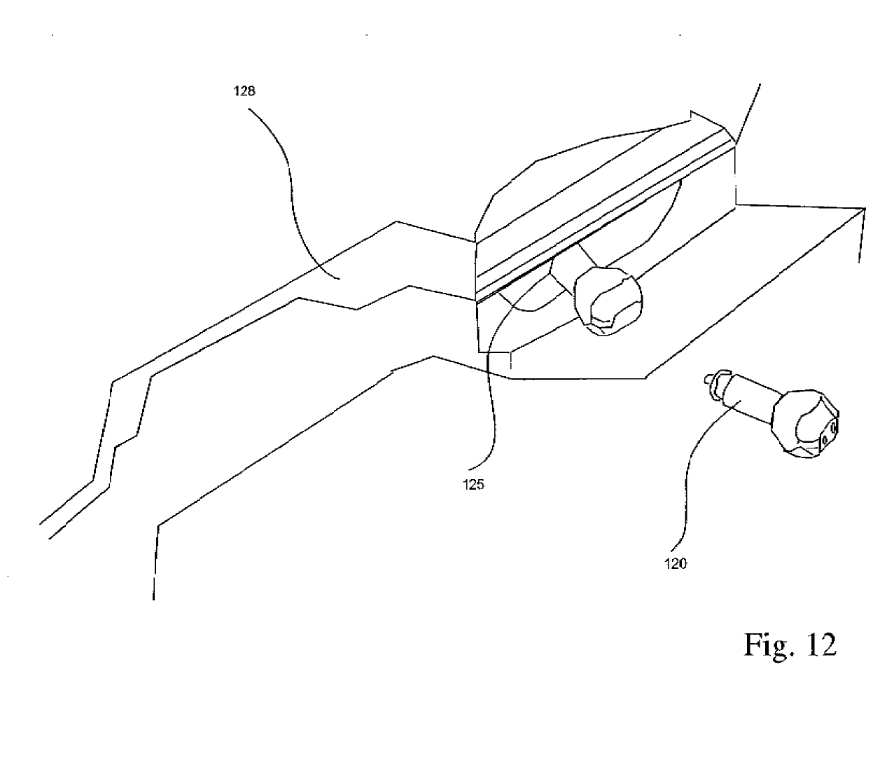

FIG. 12 illustrates the passenger cabin in-car dash board 128, where a wireless receiver 120 is plugged directly into the cigarette lighter adapter 125. The wireless receiver 120 may relay its received signals to a video monitor or a speaker or both, so that the detected image or audible signals are generated.

SELF-CONTAINED SENSOR AND ALARM. Instead of using the wireless transmission, another preferred embodiment is a self-contained sensor and speaker combination for the hitch. Power is still provided by the hitch power plug, but the sensor's detection of an object or child will cause the speaker to make loud audible, so as to alert the driver, and/or the child. In this embodiment, the wireless transmitter and receiver can be avoided, since the sensor and alarm speaker are integrated on the hitch, after-market or standard factory-installed.

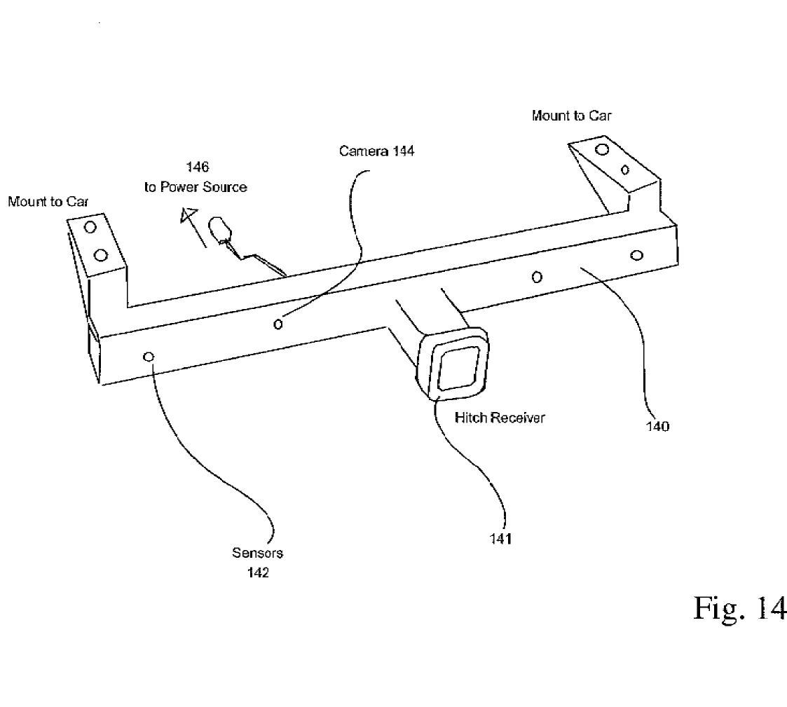

FIG. 14 illustrates an exemplary detection system based on an after-market hitch 140, where the sensors 142 or cameras 144 are built-in with the after-market hitch 140. Power is still provided by the hitch power 146 of the automobile. This way, the hitch receiver 141 is kept unused, while the after-market hitch 140 provides the sensors, cameras, lights, or combination thereof. The detection system may use a combination of sensors and cameras to provide enhanced safety features. While the cameras preferably provide a video image of the rear of the automobile, the sensors may provide a SONAR or radar type display of the rear. Additionally, audible signals may be generated at the hitch so as to alarm the driver, as well as the child in harm's way.

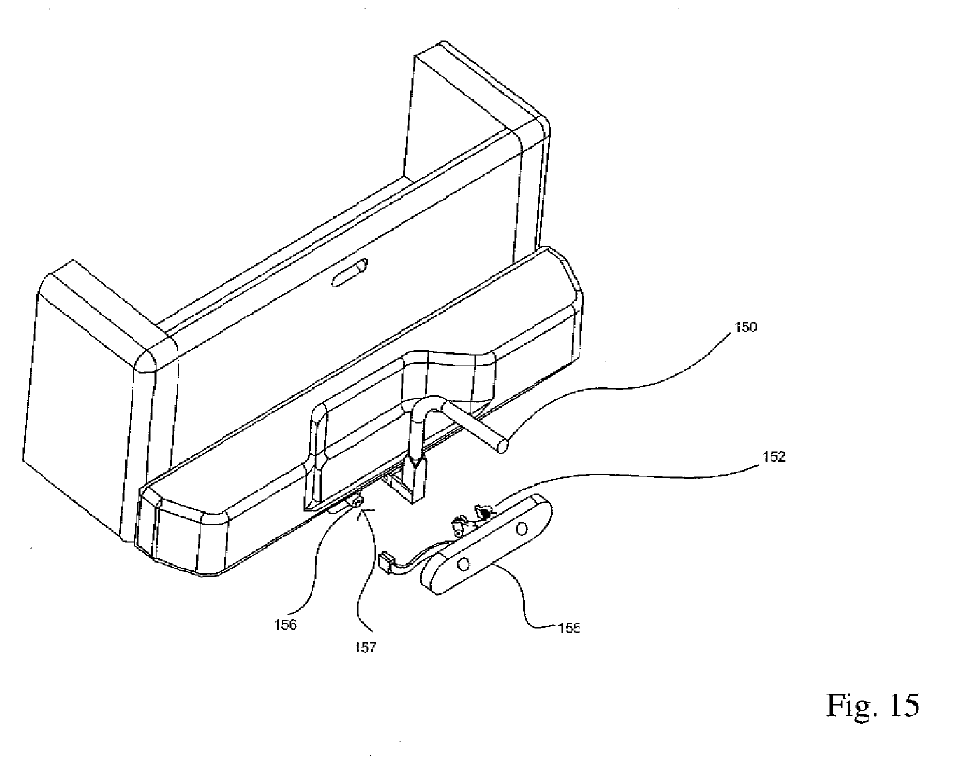

FIG. 15 illustrates a detection system 155 that is attachable or mountable to a hitch accessory 150 such a bike rack, a sports rack, a ski rack or a boat rack. By use of an attachment or mounting device 152, e.g. one or more clamp or fastener, the detection system 155 can be attached or mounted to any hitch assembly. This can be a form of retrofitting the hitch assembly. Power is still delivered from the hitch power supply 157 through the cable 156. It should be noted that the detection system is not limited to only attachment to a hitch accessory. Rather, with the attachment device 152, the detection system 155 can now be attached to any place where a detection system may be needed, such as trailer's tail or side structure of the automobile.

Although this invention has been described with reference to these specific embodiments, the descriptions are intended to be illustrative of the invention and are not intended to be limiting. Various modifications and applications may occur to those skilled in the art without departing from the true spirit and scope of the invention.

I claim:

1. A detection system for an automobile, the automobile having a hitch and a hitch power plug, and a predetermined in-cabin power source, comprising:
a hitch receptacle, disposed to be fitted to the hitch of the automobile, having a housing;
at least one detection element coupled to said housing, said detection element being adapted to scan the area behind said automobile and generate a detection signal;
a power cable adapted to releasably plug into said hitch power plug, for providing power said detection elements;
a wireless transmitter coupled to said detection element for transmitting said detection signal;
a wireless receiver for receiving said detection signal from said wireless transmitter;
a power connector adapted to be plugged into said predetermined in-cabin power source, for powering said wireless receiver;
a detection output device for receiving said detection signal.

2. The detection system of claim 1, wherein said housing has a generally rear-facing panel for positioning multiple detecting elements.

3. The detection system of claim 1, wherein said housing has a through-opening (33) aligned with said hitch, adapted to allow another hitch accessory to be connected.

4. The detection system of claim 3, wherein said housing has at least one power socket built thereon for providing power to said hitch accessory.

5. The detection system of claim 3, wherein the hitch accessory is a trailer hitch with a ball mount.

6. The detection system of claim 2, wherein the rear-facing panel has two ends which are angled to provide a wider scanning area.

7. The detection system of claim 6, wherein said panel has an opening aligned to said hitch for nestedly mounting another hitch accessory.

8. The detection system of claim 1, wherein said hitch receptacle has a frame, where said detection element is built-in.

9. The detection system of claim 8, wherein sad frame further has a generally rear facing panel for housing multiple detection elements and connecting wires.

10. The detection system of claim 1, wherein said hitch receptacle is a carrier for carrying a wheel chair or power tool, the carrier having a rear facing edge for housing the detection elements.

11. A detection system for an automobile, the automobile having a hitch and a hitch power plug, and a predetermined in-cabin power source, comprising:
at least one detection element, adapted to fit on a ball mount, said ball mount being fitted onto said hitch, said detection element being adapted to scan the area behind said automobile and generate a detection signal;
a power cable coupled to said hitch receptacle, adapted to plug into said hitch power plug, for providing power said detection elements;
a wireless transmitter coupled to said detection element for transmitting said detection signal;
a wireless receiver for receiving said detection signal from said wireless transmitter;
a power connector adapted to be plugged into said predetermined in-cabin power source, for powering said wireless receive;
a detection output device for receiving said detection signal.

12. A detection system for an automobile, the automobile having a hitch and a hitch power plug, and a predetermined in-cabin power source, comprising:
a housing adapted to fit into said hitch power plug;
at least one detection element releasably coupled to said housing, adapted to scan the area behind said automobile and generate a detection signal;
a power cable coupled to said housing for releasably plugging into said hitch power plug, for providing power said detection elements;
a wireless transmitter coupled to said detection element for transmitting said detection signal;
a wireless receiver for receiving said detection signal from said wireless transmitter;
a power connector adapted to be plugged into said predetermined in-cabin power source, for powering said wireless receive;
a detection output device for receiving said detection signal.

13. A safety detection system for an automobile having a hitch power plug, comprising:
at least one detection element provided to a predetermined area of the automobile, disposed to scan a predetermined area for an object or a child;
a detection signal generator coupled to said detection element, adapted to generate a detection signal upon scanning;
a power connector for the detection element and the signal generator, adapted to plug into the hitch power plug for deriving power therefrom.

14. The safety detection system of claim 13, wherein:
the detection element is at least one of at least one sensor or at least one camera;
the detection signal is at least one of an audible alarm or a video image.

15. The safety detection system of claim 13, further comprising:
a wireless transmitter coupled to the signal generator for transmitting the detection signal using a predetermined wireless channel;
a wireless receiver for receiving the detection signal from the wireless channel;
an in-cabin video display coupled to the wireless receiver for displaying the detection signal for viewing.

16. The safety detection system of claim 15, wherein said hitch is an after-market hitch for installation onto the automobile.

17. A back-up safety detection system for an automobile, the automobile having a hitch and a hitch power plug, and a predetermined power source, the safety detection system comprising:
a hitch assembly, adapted to fit onto the hitch;
at least one detecting element coupled to said hitch assembly, disposed to scan a predetermined area around the automobile and generate a detection signal;
a wireless transmitter coupled to the detecting element, disposed to transmit said detection signal using a predetermined wireless frequency band;
a power connector adapted to be fitted to said hitch power plug, disposed to provide power to said detecting element;
a wireless receiver for receiving said detection signal;
an output unit coupled to said wireless receiver for outputting said detection signal.

18. The detection system of claim 17, further comprising:
a processor system, for converting said detection signal into a signal suitable for display by said output unit.

19. A safety detection system for an automobile having a hitch power plug, comprising:
a hitch accessory adapted to be installed onto the automobile;
at least one detection element releasably coupled to the hitch accessory, disposed to scan a predetermined area for an object or a child;
a detection signal generator coupled to said detection element, adapted to generate a detection signal upon scanning;
a power connector for at least one of the detection element and the signal generator, adapted to releasably plug into the hitch power plug for deriving power therefrom.

20. The safety detection system of claim 19, wherein:
the detection element is at least one of at least one sensor or at least one camera.

21. The safety detection system of claim 19, further comprising:
a wireless transmitter coupled to the signal generator for transmitting the detection signal using a predetermined wireless channel;
a wireless receiver for receiving the detection signal from the wireless channel;
a processor coupled to the wireless receiver for transforming the detection signal into display data;
an in-cabin video display coupled to the processor for displaying the display data for viewing.

22. The safety detection system of claim 21, wherein said hitch accessory is an after-market hitch for installation onto the automobile.

23. The safety detection system of claim 19, wherein said detection element is releasably mounted to said hitch accessory through an attachment device.
